(19) United States
(12) Patent Application Publication
(10) Pub. No.: US 2016/0335903 A1
(43) Pub. Date: Nov. 17, 2016

(54) REAL-TIME INTERACTIVE COLLABORATION BOARD

(71) Applicant: Berlitz Investment Corporation, Princeton, NJ (US)

(72) Inventor: Claudia Marcela MENDOZA TASCON, Princeton, NJ (US)

(73) Assignee: Berlitz Investment Corporation, Princeton, NJ (US)

(21) Appl. No.: 15/223,785

(22) Filed: Jul. 29, 2016

Related U.S. Application Data
(63) Continuation of application No. 14/301,974, filed on Jun. 11, 2014, now abandoned.
Application No. 14/301,974 is a continuation of application No. 13/428,874, filed on Mar. 23, 2012, now abandoned.
(60) Provisional application No. 61/532,375, filed on Sep. 8, 2011.

(51) Int. Cl. G09B 5/14; G06F 3/0486; H04L 29/08; G06F 3/0484; H04L 29/06; G09B 19/06; G06F 17/24

(52) U.S. Cl. CPC G09B 5/14; G09B 19/06; G06F 3/0486; G06F 17/241; G06F 17/248; G06F 3/04847; H04L 65/403; H04L 67/12

(57) ABSTRACT

A real-time interactive collaboration system is provided, the system including at least: a collaboration board electronically connected between and amongst an instructor and one or more students, wherein the instructor and students are able to interact in real-time with previously uploaded objects that are part of a learning activity; means for the instructor and students to simultaneously share a predetermined view of the collaboration board; and means for the instructor and students to simultaneously share a portion of a predetermined view of the collaboration board at the discretion of the instructor. Methods of use for the foregoing system are also provided.

### STATEMENT OF RELATED CASES

The present disclosure is a Continuation of U.S. application Ser. No. 14/301,974, entitled “Real-Time Interactive Collaboration Board”, filed on Jun. 11, 2014 which is a Continuation of U.S. application Ser. No. 13/428,874, filed Mar. 23, 2012 which claims the benefit of U.S. Provisional Application Ser. No. 61/532,375, filed Sep. 8, 2011, all of which are incorporated herein in their entirety by reference thereto.

### FIELD OF THE INVENTION

The present invention relates generally to methods and systems for live, instructor-led online instruction and collaboration, and in particular though non-limiting embodiments, to methods and systems for multi-user real-time instruction and collaboration carried out over the Internet.

### BACKGROUND

In today's interactive digital world, instructor-led live online instruction is becoming increasingly prevalent. Instructor-led live online instruction can help schools and other learning institutions address the challenges of budget cuts, limited resources, local instructors' availability, expected levels of student achievement, and the technological expectations of modern students.

Furthermore, instructor-led online instruction allows for increased flexibility and personalization for a wider array of students. The use of instructor-led online instruction may range anywhere from classes which are offered entirely online (i.e., no direct face-to-face contact with the instructor or other students) to customized lessons for students in need of additional help with respect to a certain topic.

Some methods are already known in the art for enriching the content used in connection with live online instruction, although they typically lack the presence of an instructor as moderator, guide and leader of the learner's group. One such method includes systems that allow students to practice specific subjects by using a remote application and having an individual practice.

Another such method includes an instructor sharing a resource (such as Flash animation) with other participants using a web conferencing or “web sharing” tool. With this method, the interaction is one-on-one (e.g., student A [symbol] system; student B [symbol] system, student C [symbol] system, etc.), which necessarily means that each participant individually experiences the content.

For example, clicking on a link provided by an instructor results in each of the participants being able to independently view the link's content. In such a situation, the instructor does not have an option to control whether the participants are actually clicking through to the link content or to maintain a wholly-shared user experience that at the same time remains fully interactive for each of the participants, and not merely for the instructor.

Also known in the art are online games, which allow multiplayer interaction in real time. Online games may range from simple text-based games to games incorporating complex graphics and virtual worlds populated by many users simultaneously. However, in online games no single instructor is controlling the participants' activities; rather, the many users are able to alter the screen's display and the content of the game or activity simultaneously. Also, the fact that an environment supports multiple users does not guarantee that all of them are going to have the same visual point at the same time with respect to the same elements or objects within the environment.

In the field of instructor-led live online language training, the use of “direct” methods (e.g., methods in which an instructor communicates only in the target language with the students, and uses mimics, pointing to objects in the class, and body language to present new language) using a virtual classroom has proven especially problematic, especially for those students with a very limited command of the language or subject matter, even when a webcam is used, primarily because the instructors and the students are not located in the same room and do not share a single view of the object being presented or used to present the new language or subject.

Activities that are simple for face-to-face classes, such as a collaboration project on the board, a board game, card exchanges, etc., have proven virtually impossible to reproduce in a satisfactory and systematic fashion in the virtual classroom.

For example, while some existing virtual classroom and web conferencing tools include whiteboards where students can point and type at the same time on the board, boards where students can move simple shapes and text, etc., there has never been a single system that allows the instructor to predefine objects such as text and images and then repurpose them along with the functions, e.g., for different levels, subjects, goals, audiences, etc.

There has also never been a system that allows an instructor to activate and deactivate a “team play” mode depending on the purpose of the exercise, and that facilitates the synthesis and integration of all these features.

There has also never been a system that incorporates the foregoing features and allows entry of text in multi-language characters, such as Spanish, French, German, Arabic, Mandarin, etc.

There is, therefore, a long-standing yet unmet need for methods of online instruction wherein an instructor can maintain control of a game or activity and better achieve fully-integrated real-time collaboration between users and their instructor. This need is especially acute when considering the limited opportunities to customize and repurpose learning activities based on multiplayer gaming environments, for different subjects, methods, levels, learning goals, etc.

### SUMMARY OF THE INVENTION

A real-time interactive collaboration system, said system comprising: a collaboration board electronically connected between and amongst an instructor and one or more students, wherein said instructor and said one or more students are able to interact in real-time with previously uploaded objects that are part of a learning activity; means for said instructor and said one or more students to simultaneously share a predetermined view of the collaboration board; and means for said instructor and said one or more students to simultaneously share a portion of a predetermined view of the collaboration board at the discretion of the instructor. Methods of use for the foregoing system are also provided.

### BRIEF DESCRIPTION OF THE DRAWINGS

FIG. 1 is a schematic diagram illustrating a first aspect of the present invention.

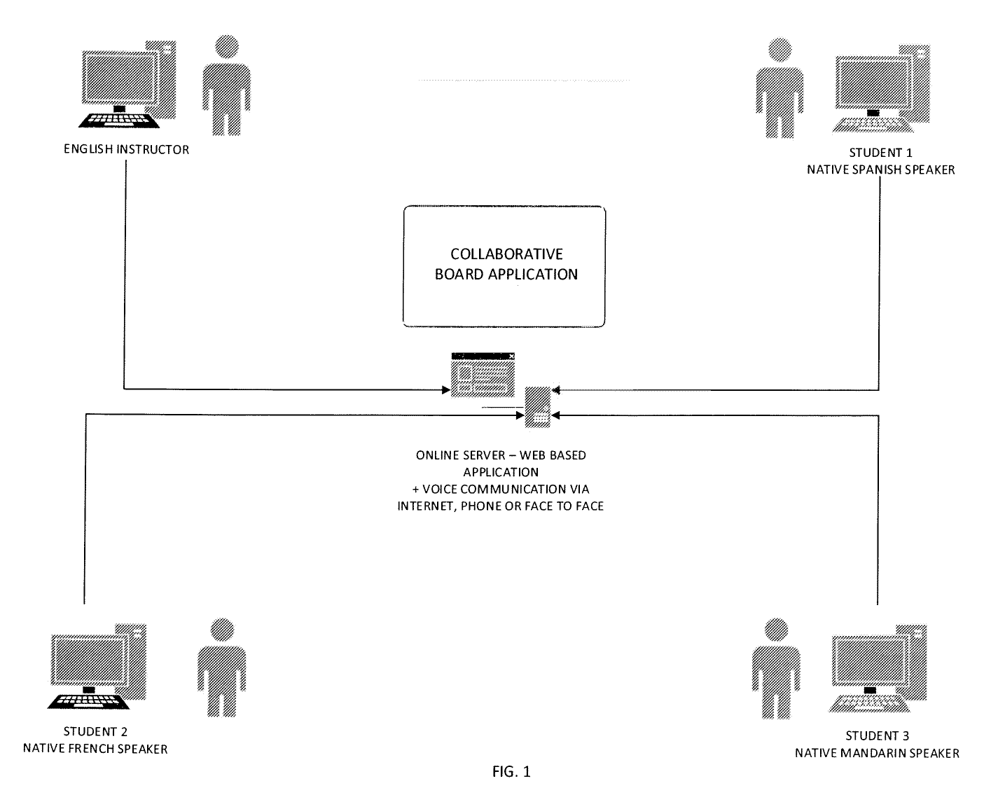

FIG. 2 is a schematic diagram illustrating a second aspect of the present invention.

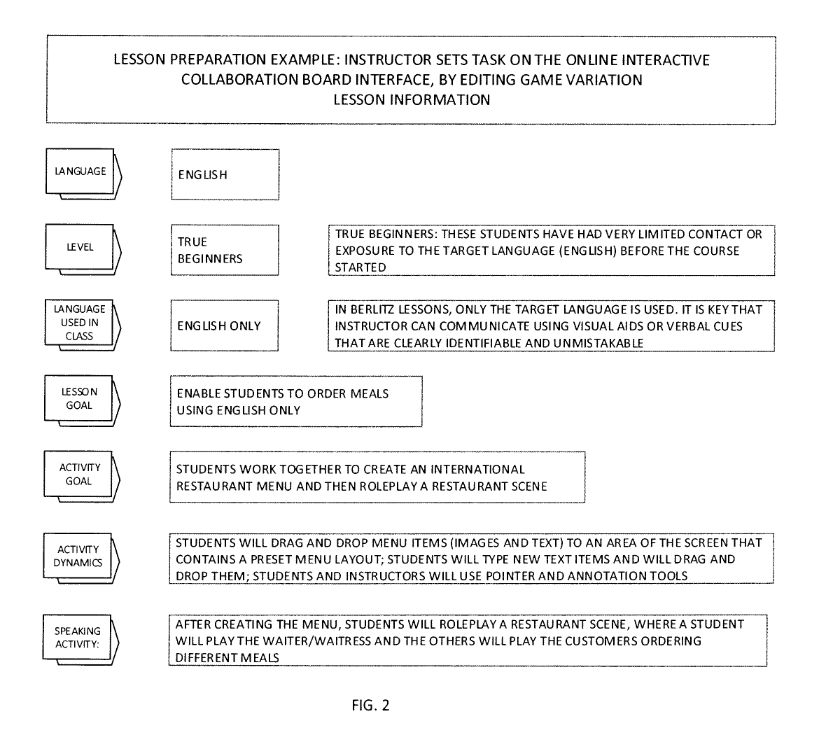

FIG. 3 is a schematic diagram illustrating a third aspect of the present invention.

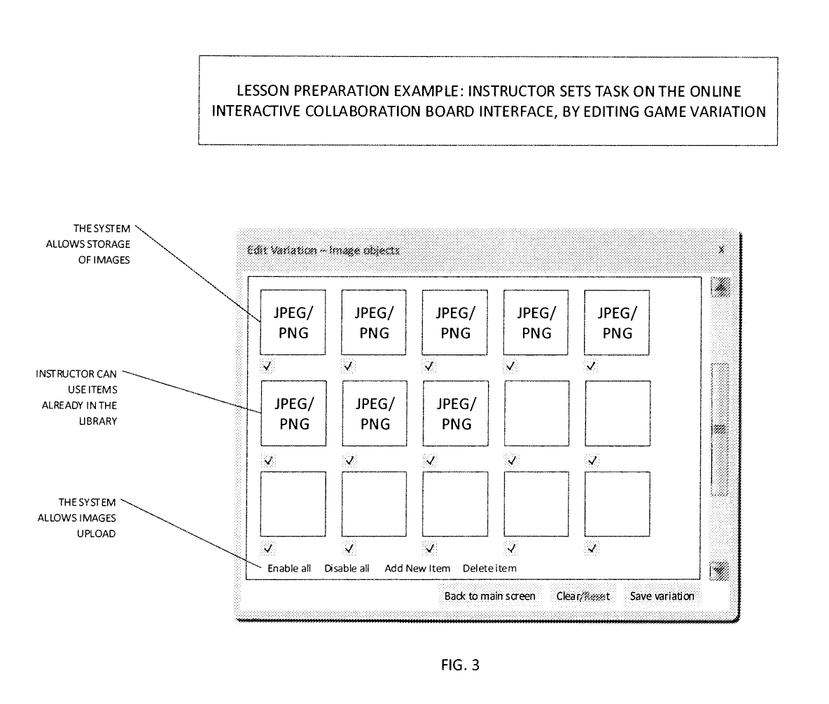

FIG. 4 is a schematic diagram illustrating a fourth aspect of the present invention.

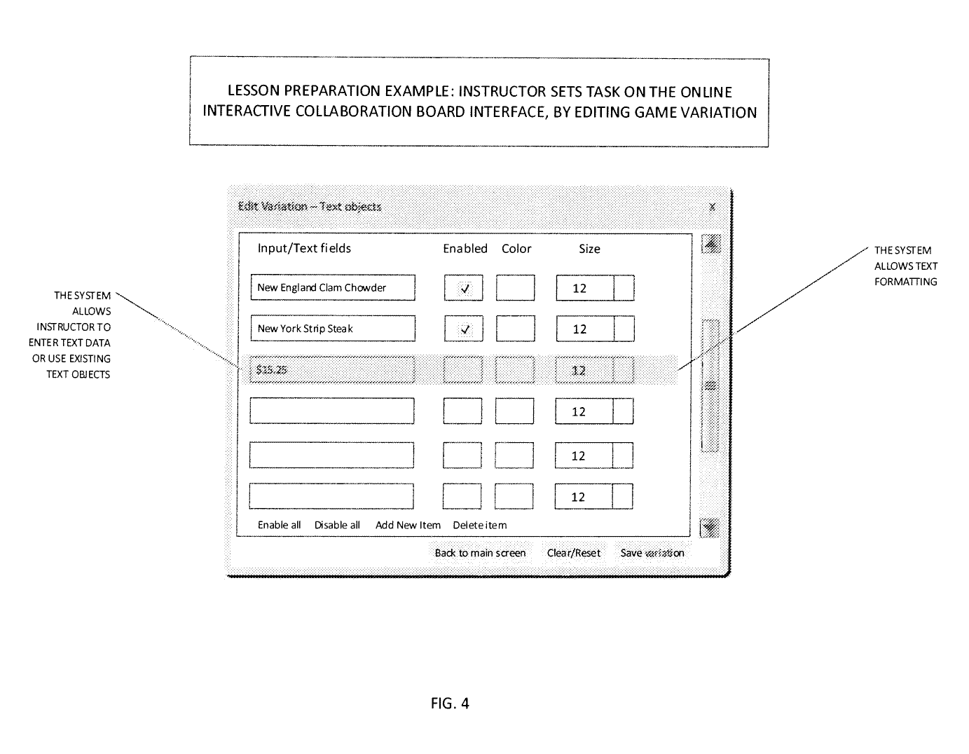

FIG. 5 is a schematic diagram illustrating a fifth aspect of the present invention.

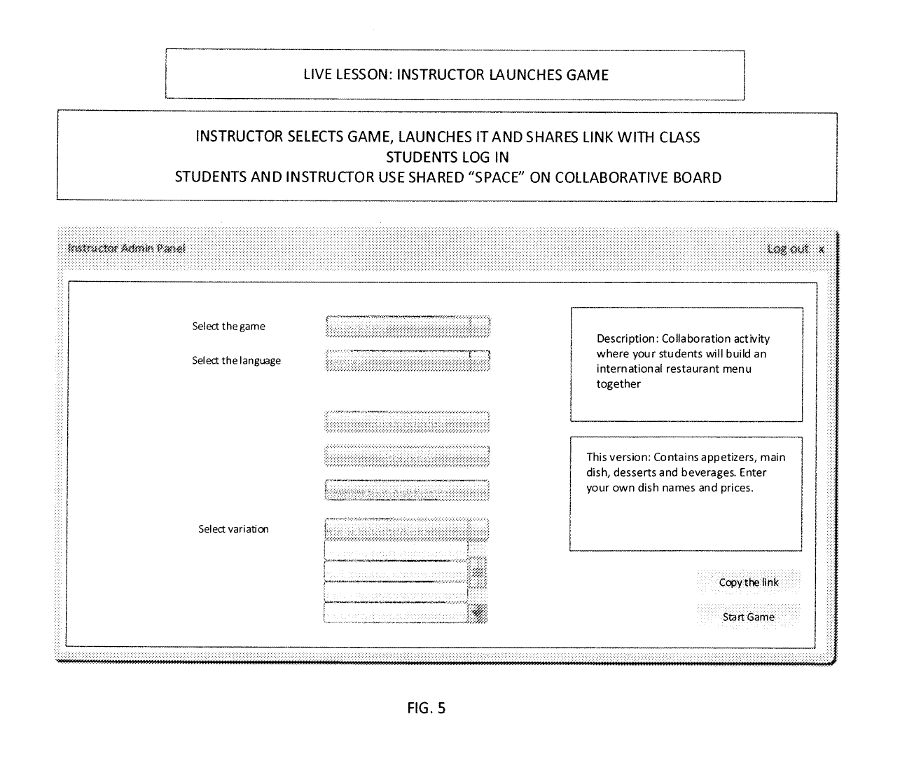

FIG. 6 is a schematic diagram illustrating a sixth aspect of the present invention.

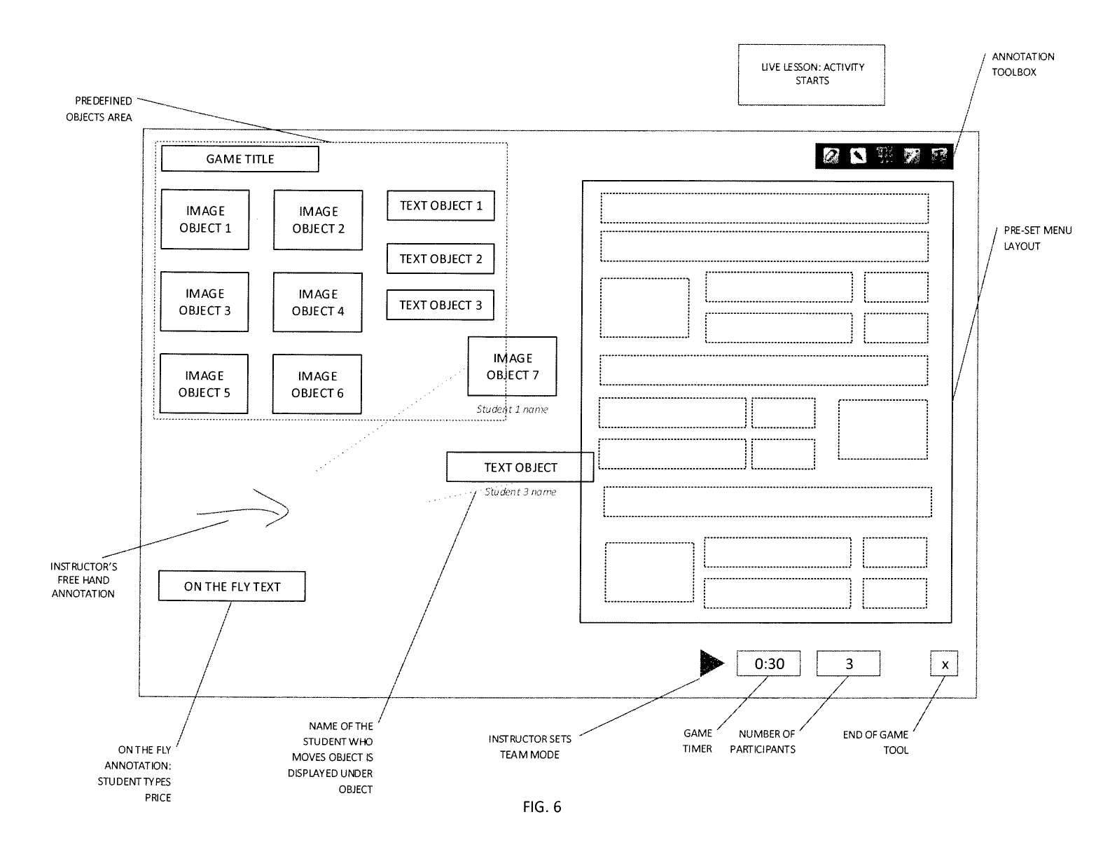

FIG. 7 is a schematic diagram illustrating a seventh aspect of the present invention.

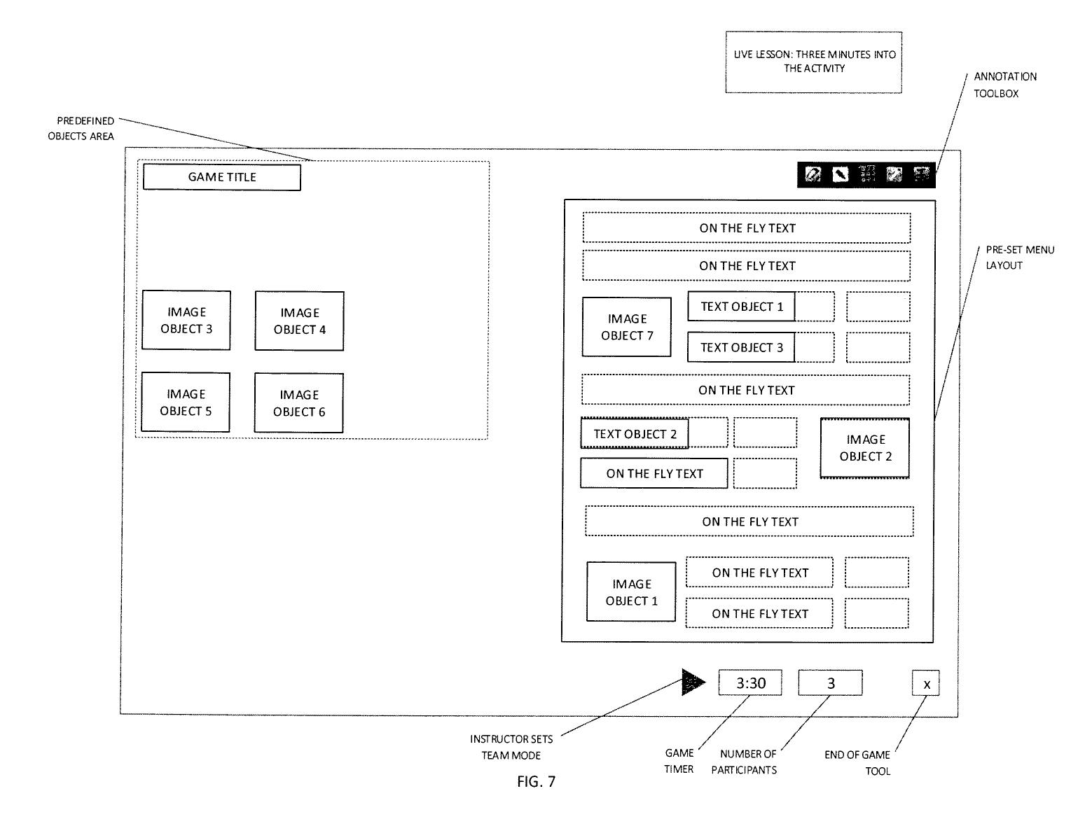

### DETAILED EXAMPLE EMBODIMENTS OF THE INVENTION

According to a presently contemplated embodiment, the present invention comprises a system and method for providing an instructor with a dynamic, multi-user, multi-player interactive board that will allow the use of direct methods for language training, which use presentation techniques that include a fully shared view for the entire group or portions thereof at the discretion of the instructor.

In another embodiment, the instructor is provided an editing capability in order to facilitate customization and repurposing of basic templates for different languages, subjects, levels and learning goals. In a further embodiment, the instructor is also provided with a link to launch the activities or games using, without limitation, one or more of: an existing web conferencing tool, any method of digital data transmission such as e-mail, instant messaging, and chat or the like. In a still further embodiment, an administrator retains editing and managing capability in order to support instructor needs, and to enable the adoption of new activities templates.

While the presently disclosed system is primarily intended for use in live, interactive settings, it does not exclude self-study uses. However, best results will be achieved when using a fully resourced, well-developed interactive direct teaching method such as the Berlitz Method®.

The invention is equally effective even when members of the learning group and the instructing group are located in remote places and using individual computers to establish communication to the disclosed system. It is assumed for the balance of this description, therefore, that a virtual classroom tool of some sort is already in place, and that instructors can share links with the students using their virtual classroom tool(s), e.g., an e-mail connection, a chat connection, a voice call or instant messages system, etc.

It will also be helpful when practicing the invention to have a live voice communication already in place between students and instructor, especially through a web collaboration tool, an IP call, or another type of remote communication system or device.

In one example embodiment, an application admits to creation of various interactive board activities or board games to be used during live instruction and other types of live collaboration. In other embodiments, the application is programmed to run in an Internet browser, including but not limited to Internet Explorer™, Firefox™ and Safari™.

In various embodiments, the application comprises a plurality of interfaces with various discrete functions, for example, (1) an administrative interface, which comprises a user and the activities and games administration panels, and functionality for testing and launching the games and activities; (2) an instructor interface, which allows named users to create new versions of activities and games based on existing versions, for example, facilitating the repurposing of the activities for other goals, languages, or levels; and (3) an end-user interface, which includes a blackboard and displays in the user's browser when the application is launched. In certain embodiments, the interactive board displays only a function and displays for which the instructor has granted the user permission to access.

In other embodiments, the administrator interface allows the system administrator to create and update “named user” accounts, and to create and modify new activities and games based upon a pre-programmed or newly-created template or templates. In other embodiments, the administrator interface comprises the capability of uploading interactive objects, such as images.

In further embodiments, game text and game descriptions are edited using the administrative interface. In still further embodiments, a plurality of additional functions are provided, including allowing the administrator to set the game's name, features, and background, create blank new games, edit existing games, delete games and integrate a design.

In yet further embodiments, the instructor interface comprises a plurality of additional options, for example, an option to select a game, display the game name, and the ability to add other game options, such as input boxes containing text.

Named users (sometimes referred to herein as “instructors”) can also create activities and games based on existing activities created by the system administrator or by using system-loaded or original templates. In certain embodiments, the instructor interface provides the instructor an ability to generate and assign discrete URL addresses to the game participants so that they can access associated content. In certain embodiments, the instructor also has the ability to integrate the design by changing the background images, colors and the game title.

In various other embodiments, the named user or instructor can log-in to the system, launch the activities in their web browser, and then share the link in order to access the activity on behalf of other users or guests. In still other embodiments, the named user acts as a moderator and has distinct privileges over one or more of the various board functions.

In further embodiments, the instructor has the ability to use the drawing tool, print the screen, pause or resume the game/activity, and display the timer, even during the game or instruction session.

In still further embodiments, once the named user and the participants are logged in, a board with various elements is displayed. The named user can then activate a “team” mode. While in the “team” mode, the participants and the named user interact in real time by moving objects and entering text, the nature and specifics of which depending on the specific activity in which the group is engaged. Furthermore, while the “team” mode is activated, users can identify other users' movements by seeing a “tooltip flag” on top of objects that other users are moving. In some embodiments, only the instructor will be able to modify the board's contents while the “team” mode is turned off.

In other embodiments, the named user sees a timer, the number of logged participants or players, a pointer, a text tool, a save tool, a team tool, and a button that creates a final screen reflecting the last status of the board. In certain embodiments, a named user ends the game and the other participants see a note or message indicating that the game is over.

In certain embodiments, the application is used in combination with web conferencing tools, such as AT&T Connect™, Adobe Connect™ or WebEx™, which allows the named user or session moderator to share web pages with session participants.

According to certain example embodiments, an instructor or participant may point and click on an object while others observe the interaction. In one example embodiment, the instructor may point to a series of objects and ask the students to collaborate and place the objects, such as images or sentences in a specific order and place on the board. Preferably, the objects (e.g., text, images, shapes, etc.) will have previously been added to the system by the administrators, and customized as necessary by the instructor in order to achieve desired lesson plan objectives.

During collaborative activities, the instructor and students can see tool-driven tips that indicate which student(s) is moving objects, and all participants can see the instructor pointing or highlighting specific items.

In other embodiments, the group of students and their instructor see text in the language previously entered by the administrator and/or instructor. In still other embodiments, the system includes a timer, which can comprise a very simple device that measures the length of time an activity has lasted, or instead a chronometer that controls the total time limit previously set for completion of the activity.

The students can either choose nicknames or use their real names once the activity is launched in their system. In still other embodiments, the students and instructor communicate using an integrated chat tool, and the messages can be seen by the entire group. In still further embodiments, the instructor can choose to send messages specifically to a student in order to offer support or exchange information.

In one embodiment, the instructor can either initiate or pause the “Team Play” mode by pointing to and clicking an associated icon. In another embodiment, the instructor can “close” the activity by pressing an icon, and the results of the collaboration board are displayed for further discussion. In a further embodiment, the instructor can type and enter text that was not included in the preset activity during the live, synchronous interaction period, and move it around the board.

In still other embodiments, the application takes advantage of SmartFox™ server capabilities. In a specific though non-limiting embodiment, the application may be used in conjunction with the Berlitz Method® program while operating in a virtual environment. However, it is also contemplated that the functionalities disclosed herein and which will otherwise occur to the reasonably skilled artisan when considering this disclosure can be expanded to support VoIP, video, document-sharing, API communication and an indefinite number of other popular programs, features and tools.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. An online interactive collaboration system, said system comprising:
an online system that allows generation of a live online synchronous collaboration board where users can view and interact with preloaded and inserted multimedia objects that are part of a learning activity, in real time, with or without moderation of an instructor, via a computer network;
a client system capable of executing the live collaboration board;
a host system, comprising:
a server capable of providing a shared environment to launch and host the client system;
a server capable of providing an ability to connect to the shared environment; and
a server capable of providing an instructor's interface in order to perorm customization tasks;
a means for the instructor and one or more users to simultaneously share a portion of a predetermined view of the collaboration board; and
means for said instructor and said one or more users to simultaneously share a portion of a predetermined view of the collaboration board only at the discretion of the instructor, who can activate or deactivate a “team module”;
wherein, the interaction includes at least one of: moving multimedia objects by dragging and dropping them from one region of the screen to other regions of the screen, inserting text by using an annotation toolbox, dragging and dropping inserted text, inserting text in preloaded text holders, annotating the screen by using a free hand mode drawing tool, erasing items by using an eraser tool, and pointing to objects by using a pointer tool;
wherein, under team mode, the instructor and the one or more users can move the multimedia objects, insert text, and use annotation tools; and
wherein, the online system has a “demonstration mode” where only the instructor can move the multimedia objects, insert text, and use annotation tools.

2. The real-time interactive collaboration system of claim 1, wherein said system further comprises:
means for an instructor to edit the content of a template associated with predefined subject matter presented on said collaboration board.

3. The real time interactive collaboration system of claim 2, wherein said means for editing further comprises means for customizing an original template for presentation on said collaboration board.

4. The real time interactive collaboration system of claim 2, wherein said means for editing further comprises means for repurposing an existing template for presentation on said collaboration board.

5. The real-time interactive collaboration system of claim 2, wherein said system further comprises:
means for customizing text and objects available within a template.

6. The real-time interactive collaboration system of claim 2, wherein said template further comprises:
text and images relevant to the study of languages.

7. The real-time interactive collaboration system of claim 1, wherein said system further comprises:
means for launching a group activity using a linked electronic activation means.

8. The real-time interactive collaboration system of claim 1, wherein said system further comprises:
means for granting an instructor moderation rights for moderating interaction between and amongst said one or more students.

9. The real-time interactive collaboration system of claim 1, wherein said system further comprises:
means for allowing and preventing interaction between individual students and discrete sub-groups thereof.

10. The real-time interactive collaboration system of claim 1, wherein said system further comprises:
means for allowing an instructor to share a partial view of said collaboration board with one or more selected students, while other students continue to view the full collaboration board.

11. A method of real-time interactive collaboration, said method comprising:
electronically connecting a collaboration board between and amongst an instructor and one or more students, wherein said instructor and said one or more students are able to interact in real-time with previously uploaded objects that are part of a learning activity;
providing a means for simultaneously sharing a predetermined view of the collaboration board between and amongst said instructor and said one or more students; and
providing a means for said instructor and said one or more students to simultaneously share a portion of a predetermined view of the collaboration board at the discretion of the instructor.

12. The real-time interactive collaboration method of claim 11, wherein said method further comprises:
editing the content of a template associated with predefined subject matter presented on said collaboration board.

13. The real time interactive collaboration method of claim 12, further comprising:
customizing an original template for presentation on said collaboration board.

14. The real time interactive collaboration methods of claim 12, further comprising:
repurposing an existing template for presentation on said collaboration board.

15. The real-time interactive collaboration method of claim 12, wherein said method further comprises:
customizing text and objects available within a template.

16. The real-time interactive collaboration method of claim 12, wherein said method further comprises:
providing a template with text and images relevant to the study of languages.

17. The real-time interactive collaboration method of claim 11, wherein said method further comprises:
launching a group activity using a linked electronic activation means.

18. The real-time interactive collaboration method of claim 11, wherein said method further comprises:
granting an instructor moderation rights for moderating interaction between and amongst said one or more students.

19. The real-time interactive collaboration method of claim 11, wherein said method further comprises:
allowing and preventing on-board interaction between individual students and discrete sub-groups thereof.

20. The real-time interactive collaboration method of claim 11, wherein said method further comprises:
allowing an instructor to share a partial view of said collaboration board with one or more selected students, while other students continue to view the full collaboration board.
